(19) United States
(12) Patent Application Publication
(10) Pub. No.: US 2004/0137116 A1
(43) Pub. Date: Jul. 15, 2004

(54) Method for processing and preserving food and processed food

(76) Inventor: Katsunori Saito, Yokohama-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/473,739

(22) PCT Filed: Apr. 2, 2002
(86) PCT No.: PCT/JP02/03299

(30) Foreign Application Priority Data
Apr. 4, 2001 (JP) 2001-106332
Apr. 4, 2001 (JP) 2001-106333

(51) Int. Cl. C12C 1/027

(52) U.S. Cl. 426/106

(57) ABSTRACT

A method for processing and preserving foods includes a processing step of holding a seasoned food in a packaging member in a state in which the food is in contact with a dehydrating sheet, and a preservation step of preserving the food by cold or frozen storage while maintaining the holding state. The packaging member can be a packaging bag and a container, and can be designed according to the user's need. According to this method, it becomes possible to provide processed foods with superior freshness at a low cost.

### DESCRIPTION

1. Technical Field

The present invention relates to a method for processing and preserving foods and also relates to processed foods.

2. Background Art

A dehydrating sheet obtained by interposing a highly osmotic substance such as starch syrup between semipermeable membranes comprising a polyvinyl alcohol has been heretofore used for processing foods such as fish meat.

For example, a fish meat is salted and is then wrapped or sandwiched by a dehydrating sheet, whereby water inside the fish meat can be removed and dried fish can be produced. According to this method, a dried fish can be produced at either an ordinary temperature or a refrigerating temperature, and as compared with conventional methods using a dryer or by solar drying, ash drying or the like, dried fish can be hygienically obtained at a low temperature while maintaining freshness. When a fish meat is seasoned with miso (fermented salted soybean paste), mirin (sweet sake), soy sauce, or lees, and is then similarly wrapped or sandwiched by a dehydrating sheet, the removal of water inside the fish meat and the soaking in seasoning can be performed at the same time, so that the penetration of seasoning into the fish flesh can be enhanced and marinated fish can be efficiently produced within a short period of time using a small amount of seasoning. In addition, smoked foods are also produced using a smoking solution containing a flavor for imparting a smoke flavor.

The dehydrating sheet is used not only for this food processing but also for the preservation or transportation of food in a cold or frozen state. In the case of freezing a food such as fish meat, extra water is removed using a dehydrating sheet before freezing so that the fish meat can be prevented from freezing damage and good food quality can be maintained. Also, when extra water, corresponding to dripping is previously removed using a dehydrating sheet, the generation of dripping can be prevented at thawing or during cold storage.

However, if a dehydrating sheet is used as such in respective steps of food processing, cold/frozen storage, and transportation, an operation for preparing a dehydrating sheet and wrapping a food or removing the dehydrating sheet from the food must be performed at every each step.

Furthermore, when a dehydrating sheet is used at every each step, this is disadvantageous in that the cost for the dehydrating sheet is increased, much time and much labor are required, and the amount of discarded dehydrating sheet increases.

The present invention has been made under these circumstances and the object of the present invention is to provide processed foods with high freshness at a low cost.

### DISCLOSURE OF INVENTION

A method for processing and preserving foods of the present invention comprises a processing step of holding a seasoned food in a packaging member, such as a packaging bag and a container, in a state such that the food contacts a dehydrating sheet, and a preservation step of preserving the food by cold or frozen storage while maintaining the holding state.

In this method, the preservation step is preferably performed by frozen storage.

In this method, the packaging member is preferably designed according to the user of the processed food.

In this method, the preservation step may contain a transportation step of transporting the processed food while maintaining the holding state and while preserving the food by cold or frozen storage.

The method for processing and preserving foods of the present invention is suitable for processing and preserving fish meat and the processing step is preferably a dried fish production step, a marinated fish production step or a smoked fish production step.

The processed food of the present invention is characterized in that a seasoned food is processed by holding it in a packaging member, such as a packaging bag and a container, in a state such that the food is in contact with the dehydrating sheet and is preserved by cold or frozen storage while maintaining the holding state.

In this processed food, the preservation is preferably preformed by frozen storage.

In this processed food, the packaging member, such as a packaging bag and a container, is preferably designed according to the user of the processed food.

In this processed food, the preservation step includes a transportation step of transporting the processed food while maintaining the holding state and while preserving the food by cold or frozen storage.

In this processed food, the food is suitably a fish meat.

In this processed food, the food is suitably a dried fish, a marinated fish, or a smoked fish.

### BEST MODE FOR CARRYING OUT THE INVENTION

The present invention is described in detail below. The method for processing and preserving foods of the present invention comprises a processing step of holding a seasoned food in a packaging member, such as a packaging bag or a container, in a state such that the food is in contact with a dehydrating sheet.

The seasoning used in the processing step is not particularly limited and examples thereof include salt, sugar, miso (fermented salted soybean paste), mirin (sweet sake), soy sauce, liquor, and lees. These seasonings may also be used as a mixture of two or more thereof. Also, a smoking solution comprising a flavoring for imparting a smoke flavor and if desired, having mixed therein salt, sugar, and various spices, may be used.

The food is not particularly limited and in addition to meats such as that of fish, beef, chicken, and pork, vegetables and fruits can also be used.

Examples of the processing step include a dried fish production step, a marinated fish production step, and a smoked fish production step. More specifically, when a fish meat is used as a food, and a salt as a seasoning is added to this fish meat by shaking the salt thereon or using a salt water, a dried fish can be produced. When the seasoning used is miso, mirin, soy sauce, or lees, a marinated fish can be produced. Furthermore, a smoked fish can also be produced by using a smoking solution as the seasoning.

The processing step may be performed at an ordinary temperature, but when this step is performed at a refrigerating temperature, the freshness of the food can be maintained higher.

The food is preferably preprocessed into only eatable parts in advance of the processing step. For example, in the case where the food is a fish meat, the head, fin, bones, internal organs and the like of the fish are preferably removed in advance. By removing unnecessary parts, the amount of waste generated in later steps can be reduced, and at the same time, the space for preservation can be effectively used in the later preservation step.

In this way, by adding a seasoning to a food and holding the food in a packaging member, such as a packaging bag or a container, in a state such that the food is in contact with a dehydrating sheet, the seasoning can be penetrated into the food while removing excess water inside the food with the dehydrating sheet. As a result, not only is the penetrability of seasoning into a food enhanced, but also the seasoning can be prevented from being diluted with excess water, so that the food can be efficiently processed using a small amount of seasoning within a short period of time. Also, since the processing is performed while removing excess water, freshness can be maintained. Furthermore, since excess water is removed as such in this processing step, freezing damage during frozen storage or the generation of drips in cold storage can be prevented in the later preservation step.

According to this method, for example, a dried fish can be produced even at a refrigerating temperature without exposing the fish directly to an outside air; therefore, as compared with conventional methods using a dryer or by solar or ash drying, the production can be hygienically performed, and at the same time, the obtained dried fish can have superior freshness. In the case of solar drying or ash drying, a salt must be added in a predetermined amount or more so as to prevent putrefaction of the fish meat, however, according to the above-described method, a dried fish can be produced while holding the fish meat in a cold state, so that the putrefaction of the fish meat can be prevented even without using an excess salt.

As for specific examples of the method for holding a seasoned food in a packaging bag in a state such that the food is in contact with a dehydrating sheet, a food having a seasoning spread or sprinkled thereon may be sandwiched or wrapped with a dehydrating sheet and placed and held in a packaging bag. Also, the dehydrating sheet and the food may be alternately placed one on another in order. In this case, the number of food stages is preferably from 1 to 3. If the number of stages exceeds 3, the food temperature within the packaging bag cannot be uniformly controlled in some cases. A long dehydrating sheet may also be used by repeatedly folding it to hold a seasoned food therebetween. Also, seasoned foods may be individually contained in bags each formed of a dehydrating sheet.

Similarly, the method of holding a seasoned food in a container in the state of the food contacting with a dehydrating sheet is not particularly limited, and specific examples thereof include a method of sandwiching or wrapping a food having a seasoning spread or sprinkled thereon with a dehydrating sheet and placing and holding the food in a container, and a method of laying a dehydrating sheet in a container and placing thereon a food having a seasoning spread or sprinkled thereon. After placing a food on a dehydrating sheet, a dehydrating sheet and a food may further be alternately placed thereon in order. In this case, the number of food stages is preferably from 1 to 3. If the number of stages exceeds 3, the food temperature within the container cannot be uniformly controlled in some cases. A long dehydrating sheet may also be used by repeatedly folding it to hold a seasoned food therebetween. Also, seasoned foods may be individually contained in bags each formed of a dehydrating sheet.

The dehydrating sheet is not limited insofar as it has a dehydrating ability of removing water from the inside of a food, and examples thereof include an osmotic dehydrating sheet comprising a highly osmotic substance interposed between two semipermeable membranes.

Examples of the highly osmotic substance include an aqueous solution of saccharides such as starch syrup, sugar, isomerized sugar, glucose, fructose, mannitol, sorbitol or reduced starch syrup, glycerin and propylene glycol, each having an osmotic pressure of 10 atm or more. In the case of using these highly osmotic substances, the aqueous adhesive paste disclosed in JP-B-4-33491 (the term “JP-B” as used herein means an “examined Japanese patent publication”) is preferably used by adding it to the high osmotic substance so that even when the highly osmotic substance absorbs water, a constant viscosity can be maintained.

Examples of the semipermeable membrane include common cellophane, laminate film of common cellophane and paper, polyvinyl alcohol film, collodion membrane, ethylene-vinyl acetate copolymer film and polyamide film. Among these, polyvinyl alcohol film is preferred.

Other examples of the dehydrating sheet include a dehydrating sheet comprising a water-absorbing layer and a permeable material provided on at least one surface thereof.

The water-absorbing layer is composed of a water absorbent polymer as a high water-absorption substance, or a substance capable of absorbing water by capillary phenomenon. To the water-absorbing layer, a moisture absorbent comprising a polyhydric alcohol such as glycerol or propylene glycol may be added to improve the moisture-absorption capacity.

For the absorbent polymer, those generally used for sanitary goods, paper diapers, soil improvers and the like may be used. Specific examples thereof include polymers obtained by graft-polymerizing a polymerizable monomer which is water-soluble or becomes water-soluble by hydrolysis, or an oligomer or co-oligomer of this polymerizable monomer, to a polysaccharide such as starch and cellulose, followed by hydrolysis, if desired, and crosslinking the obtained hydrophilic polymer with a crosslinking agent to have a three-dimensional structure. Examples of the polymerizable monomer include acrylic acid, methacrylic acid, maleic acid, their salts and derivatives such as esters and amides, and acrylonitrile. Other than these, the absorbent polymer may be obtained by crosslinking a hydrophilic polymer using a crosslinking agent to have a three-dimensional structure and examples of the hydrophilic polymer include polyalkylene oxides such as polyethylene oxide and polypropylene oxide; N-vinyl compound polymers such as poly-N-vinylpyrrolidone, poly-N-vinylacetamide and poly-N-vinylformamide; polyacrylic acid, polymethacrylic acid and their salts and derivatives such as esters and amides; and polyacrylamide.

These absorbent polymers may be used in the form of powder or fiber or in the state of being sandwiched by or supported on pulp or nonwoven fabric.

The substance utilizing capillary action may be sufficient if it is a substance having a large surface area and a structure for forming capillaries and holding water, for example, a cotton-, cloth-, or nonwoven fabric-like substance having a fiber-to-fiber distance of 500 μm or less, or a foamed substance having continuous cells (continuous porous substance). A hydrophilic material is more preferred. Specifically, preferred examples thereof include a substance obtained by flocculently gathering hydrophilic fibers such as pulp, cotton, polyamide fiber or polyvinyl alcohol fiber, and a continuous cell-type foamed substance of synthetic resin, such as synthetic fiber nonwoven fabric and foamed urethane.

Examples of the permeable material include paper, pulp, cloth, nonwoven fabric, a continuous cell-type foamed material, and a material obtained by providing a large number of micropores on impermeable film such as polyolefin film.

Among the above-described dehydrating sheets, an osmotic dehydrating sheet comprising a high osmotic substance sandwiched by two semipermeable membranes is more preferred. When such a dehydrating sheet is used, water can be uniformly removed from the inside of food.

In the present invention, a high water-absorption dehydrating sheet having a high water-absorption capacity is preferably used. The high water-absorption dehydrating sheet as used herein means a dehydrating sheet having a capacity of, even after the absorption of water from a food in a processing step, further absorbing drips and the like generated from the food in a later preservation step. Examples of this high water-absorption dehydrating sheet include an osmotic dehydrating sheet obtained by sealing 2 mol/m² or more, and preferably, in view of the cost, from 2 to 8 mol/m², of a high osmotic substance between two polyvinyl alcohol film sheets which are a semipermeable membrane.

In the present invention, the processing of a food is performed by holding a seasoned food in a packaging member, such as a packaging bag and a container, while contacting the food with the above-described dehydrating sheet for a predetermined time at an ordinary or refrigerating temperature. While maintaining this holding state, more specifically, without taking out the dehydrating sheet from the packaging member or transferring the processed food into other packaging member, the preservation step of preserving the processed food by cold or frozen storage is performed. Incidentally, the preservation step may be performed in cold storage or frozen storage, but frozen storage is preferred. In the frozen storage, the movement of water or seasoning is stopped, so that excess progression of processing can be more reliably stopped.

By performing the processing step and the preservation step as such, the dehydrating sheet used in the processing step can be continuously used as it is in the preservation step. As a result, after the processing step is performed with good efficiency using a small amount of seasoning while removing excess water, the preservation step can further be performed while removing excess water by the same dehydrating sheet and thereby preventing freeze damage at the freezing or generation of drips at the thawing or cold storage.

Accordingly, a high-quality processed food maintaining the same freshness as that immediately after the processing step can be obtained even after the preservation step. Furthermore, since the dehydrating sheet used in the processing step need not be removed and the same dehydrating sheet can be used as it is also in the preservation step, not only can the cost of the dehydrating sheet be halved, but also the time and labor for removing the dehydrating sheet or repacking the food can be dispensed with. In addition, if a packaging bag is used, by virtue of the vacuum state inside the packaging bag, a high-quality processed food having higher freshness can be obtained.

In the case where the preservation step includes a transportation step of transporting the food while maintaining the holding state and preserving the food by cold or frozen storage, the same dehydrating sheet can also be continuously used. Therefore, even when water is generated at the surface of food due to drips, the water can be effectively removed. Since water can be effectively removed as such, high freshness can be maintained also in the case of transporting the food for a long period of time, over a long distance overseas, or the like.

In this way, the processing step of holding a seasoned food in a packaging member, such as a packaging bag and a container, while contacting the food with a dehydrating sheet, and the preservation step of preserving the processed food by the cold or frozen storage while keeping the holding state are performed, whereby foods having high freshness can be provided to consumers at a low cost.

In the processing step and the preservation step, a refrigerating and freezing apparatus capable of performing both refrigeration and freezing by changing the setting temperature may be used to continuously perform the processing step and the preservation step within this refrigeration and freezing apparatus. Furthermore, a plurality of packaging bags may be placed in a box or basket and piled one on another on a frame or a carriage, or a plurality of containers each preserving a food and each placed on a frame or a carriage may be piled one on another, whereby, for example, even when the processing step is performed in a refrigerating apparatus and the preservation step is performed in a separate freezing apparatus, the transportation between the refrigerating apparatus and the freezing apparatus can be facilitated.

The packaging bag for holding the food is not particularly limited in the size, construction material, and shape, and these can be appropriately selected according to the kind and the amount of food.

For example, a polyolefin-base resin-made hermetically sealable packaging bag is preferred because this can be recycled, is inexpensive, and is easy to treat as waste when discarded. A packaging bag capable of vacuum packaging which comprises a laminate of polyethylene and a resin selected from the group consisting of polyamide, saponified ethylene-vinyl acetate copolymer, and polyvinyl alcohol is more preferred because this can prevent food oxidation, ensures excellent dehydrating stability, and gives a good appearance.

When the processing step and the preservation step are performed in the state of the food being held in such a packaging bag, each step can be performed while preventing the leakage of seasoning. Furthermore, as compared with conventional methods using a box or the like composed of a foamed substance, the amount of material used for packaging can be small, and therefore, the total amount of waste can be reduced. In addition, when a small-size packaging bag is used, the food temperature can be easily controlled.

Similarly, the container for holding the food is not particularly limited in the size, construction material, and shape, insofar as the container can be satisfactorily heat-conductive and transmit cool air to the food within a relatively short period of time, and these can be appropriately selected according to the kind and the amount of food.

For example, a water-resistant cardboard-made box-type container is preferably used because this can be recycled, is inexpensive, and is easy to treat as waste when discarded. In anticipation of reuse, a tray or container comprising a metal or plastic may also be used. Furthermore, a container which can be stacked or folded may be used to enhance the handleability. Also, use of a container having formed thereon an air hole or a container having a large surface area, for example, a flat, low profile container, is preferred because the heat conductivity is increased.

In addition, the container may have an inner bag made of polyethylene so as to prevent the leakage of seasoning. When the processing step and the preservation step are performed while holding a food in such a container, the food with the container can be piled up and transported or preserved, and this is preferred in view of handleability.

In the present invention, the packaging member, such as a packaging bag or a container, which is used is preferably designed according to the user of the processed food.

For example, in the case where the food after the processing step and the preservation step is wholesaled to a retail dealer and is sold at a retail shop such as a supermarket, a packaging bag or container capable of holding a small amount of food, specifically, a packaging bag or container capable of individually packaging a meat, is used in anticipation of the sale at a retail store. On the other hand, in the case where the food after the processing step and the preservation step is shipped to a restaurant or the like, a packaging bag or container having a size large enough to hold a food in an amount according to the needs of the restaurant is used in the processing step.

When a packaging bag or container previously designed according to the user of the food is used as such in the processing step, an operation of transferring the food to another packaging bag or container, or subdividing the food, is not necessary at all, not only in the course from the processing step to the preservation step, but also until the food reaches the user after the preservation step, and the food in the processed form as it is can be displayed in the shopwindow of a retail store and sold to consumers or can be provided to restaurants. In particular, the packaging bag is inexpensive, and therefore, even when fillets of a fish meat are packaged individually, it does not cost very much. Furthermore, the dehydrating sheet can be effectively used to the maximum until the food reaches the user and at the same time, superior freshness can be maintained until the food reaches the user. As compared with the case of using separate dehydrating sheets in respective steps, time and labor can be saved and the cost reduced, and the amount of waste can be reduced to the minimum. Furthermore, since an operation for transferring the food to another packaging bag or container, or subdividing the food is not necessary, the production is hygienic and the control of stock or usable term is facilitated. The easy control of the usable term is advantageous in that the amount of food discarded due to expiration of the usable term can be reduced.

This method for processing and preserving foods comprises a processing step of holding a seasoned food in a packaging member, such as a packaging bag and container, in a state such that the food is in contact with a dehydrating sheet and a preservation step of preserving the food by the cold or frozen storage while maintaining the holding state, so that the dehydrating sheet used in the processing step can be continuously used also in the preservation step, the processing step can be performed efficiently and hygienically, and the subsequent preservation step can be performed without degrading the freshness immediately after the processing step. In other words, according to this method for processing and preserving foods, a high-quality food can be provided at a low cost by saving the time and labor for replacing the dehydrating sheet or packaging member, such as a packaging bag and a container.

The packaging member, such as a packaging bag or container, which is used is in particular a packaging member designed according to the user of the processed food, so that the dehydrating sheet can be very effectively used, the amount of waste can be reduced, and at the same time, a food having higher freshness can be provided to the user.

According to this method, a food maintaining high freshness can be provided to the user; therefore, this method is optimally used in particular for fish meat of which freshness is important.

### EXAMPLES

The present invention is described below in greater detail by referring to Examples 1-6.

### Example 1

A dried horse mackerel was produced as follows.

A horse mackerel, from which inedible parts were removed, was filleted into three pieces, and the fillets were slightly washed and slightly salted. Out of these, one fillet was sandwiched by a dehydrating sheet of 12×17 cm (a dehydrating sheet obtained by sealing 2 mol/m² of a highly osmotic substance between two polyvinyl alcohol film sheets) having a high water-absorption capacity. The fillets, each processed as such, were individually placed in packaging bags of 8×15 cm composed of a laminate of polyamide and polyethylene, and these packaging bags were vacuum packaged and then placed side by side in a cardboard-made box of 50×35×5 cm.

A plurality of these boxes made of cardboard were placed on a pallet at constant intervals, and on each box, similar boxes were piled up 10 high. These boxes were placed in a refrigerator controlled to a temperature of 5° C. and after being left standing overnight, were transferred together with the pallet to a freezer controlled to a temperature of −20° C., where the fillets were frozen. Thereafter, these fillets were sold wholesale to a retail store and were thawed there at an ordinary temperature; as a result, high-quality delicious dried horse mackerel maintaining high freshness was obtained.

### Example 2

A dried horse mackerel was produced as follows.

A water-resistant box-type container made of cardboard having a bottom face of 50×35 cm and a height of 5 cm was prepared, and on this bottom, a dehydrating sheet of 50×70 cm (a dehydrating sheet obtained by sealing 2 mol/m² of a highly osmotic substance between two polyvinyl alcohol film sheets) having a high water-absorption capacity, which was doubled over, was laid. A horse mackerel, from which inedible parts were removed, was filleted into three pieces and the fillets were slightly washed, slightly salted, placed side by side on the dehydrating sheet, and covered with the same dehydrating sheet from the above, and then a cover was put on the container. A plurality of these containers were placed on a pallet at constant intervals and on each container, similar containers were piled up to 10 high. These containers were placed in a refrigerator controlled to a temperature of 5° C. and after being left standing overnight, were transferred together with the pallet to a freezer controlled to a temperature of −20° C., where the fillets were frozen. Thereafter, these fillets were sold wholesale to a restaurant and were thawed there at an ordinary temperature, and as a result, high-quality delicious dried horse mackerel maintaining high freshness was obtained.

### Example 3

A miso-marinated sea bream was produced as follows.

Miso was spread on a dehydrating sheet of 12×17 cm (a dehydrating sheet obtained by sealing 2 mol/M² of a highly osmotic substance between two polyvinyl alcohol film sheets) having a high water-absorption capacity and one fillet of sea bream was sandwiched by this dehydrating sheet. The fillets each processed as such were individually placed in packaging bags of 8×15 cm composed of a laminate of polyamide and polyethylene and these packaging bags were vacuum packaged and then placed side by side in a cardboard-made box of 50×35×5 cm.

A plurality of these boxes made of cardboard were placed on a pallet at constant intervals and on each box, similar boxes were piled up 10 high. These boxes were placed in a refrigerator controlled to a temperature of 5° C. and after being left standing overnight, were transferred together with the pallet to a freezer controlled to a temperature of −20° C., where the fillets were frozen. Thereafter, these fillets were sold wholesale to a retail store and were thawed there at an ordinary temperature, and as a result, high-quality delicious miso-marinated sea bream maintaining high freshness was obtained.

### Example 4

A miso-marinated sea bream was produced as follows.

A water-resistant box-type container made of cardboard having a bottom face of 50×35 cm and a height of 5 cm was prepared. On this bottom, a polyethylene sheet of 110×80 cm was laid and thereon, a dehydrating sheet (a dehydrating sheet obtained by sealing 2 mol/m² of a highly osmotic substance between two polyvinyl alcohol film sheets) having a high water-absorption capacity, which was doubled over, was laid. On this dehydrating sheet, miso was spread, and thereon, fillets of sea bream were placed side by side. On these fillets, miso was further spread and thereon, the another dehydrating sheet was laid. The polyethylene sheet laid on the bottom was turned up to cover the upper part, and then a cover was put on the container. A plurality of these containers were placed on a pallet at constant intervals and on each container, similar containers were piled up 10 high. These containers were placed in a refrigerator controlled to a temperature of 5° C. and after being left standing overnight, were transferred together with the pallet to a freezer controlled to a temperature of −20° C, where the fillets were frozen. Thereafter, these fillets were sold wholesale to a restaurant and were thawed there at an ordinary temperature, and as a result, high-quality delicious miso-marinated sea bream maintaining high freshness was obtained.

### Example 5

A smoked salmon was produced as follows.

One fillet of salmon to which a smoking solution had been applied and which had been slightly salted was sandwiched by a dehydrating sheet of 12×17 cm (a dehydrating sheet obtained by sealing 2 mol/m² of a highly osmotic substance between two polyvinyl alcohol film sheets) having a high water-absorption capacity. The fillets each processed as such were individually placed in packaging bags of 8×15 cm composed of a laminate of polyamide and polyethylene and these packaging bags were vacuum packaged and then placed side by side in a box made of cardboard of 50×35×5 cm.

A plurality of these boxes made of cardboard were placed on a pallet at constant intervals and on each box, similar boxes were piled up 10 high. These boxes were placed in a refrigerator controlled to a temperature of 5° C., and after being left standing overnight, were transferred together with the pallet to a freezer controlled to a temperature of −20° C., where the fillets were frozen. Thereafter, these fillets were sold wholesale to a retail store and were thawed there at an ordinary temperature, and as a result, high-quality delicious smoked salmon maintaining high freshness was obtained.

### Example 6

A smoked salmon was produced as follows.

A water-resistant box-type container made of cardboard having a bottom face of 50×35 cm and a height of 5 cm was prepared and on this bottom, a dehydrating sheet (a dehydrating sheet obtained by sealing 2 mol/m² of a highly osmotic substance between two polyvinyl alcohol film sheets) having a high water-absorption capacity, which was doubled over, was laid. On this dehydrating sheet, salmon fillets to which a smoking solution had been applied and which had been slightly salted, were placed side by side and were covered with the same dehydrating sheet, and then a cover was put on the container. A plurality of these containers were placed on a pallet at constant intervals, and on each container, similar containers were piled up 10 high. These containers were placed in a refrigerator controlled to a temperature of 5° C. and after being left standing overnight, and were transferred together with the pallet to a freezer controlled to a temperature of −20° C., where the fillets were frozen. Thereafter, these fillets were sold wholesale to a restaurant and were thawed there at an ordinary temperature, and as a result, high-quality delicious smoked salmon maintaining high freshness was obtained.

### Industrial Applicability

As described in the foregoing, the method for processing and preserving foods of the present invention comprises a processing step of holding a seasoned food in a packaging member, such as a packaging bag or container, in a state such that the food is in contact with a dehydrating sheet and a preservation step of preserving the food by the cold or frozen storage while maintaining the holding state, so that a high-quality food can be provided at a low cost by saving time and labor for replacing the dehydrating sheet or packaging member.

The packaging member used is, in particular, a packaging bag or a container designed according to the user of the processed food, so that the dehydrating sheet can be very effectively used, the amount of waste can be reduced, and at the same time, a food having higher freshness can be provided to the user.

The thus-produced processed food of the present invention is inexpensive, and moreover, is favored with superior freshness and taste.

Having thus described several exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the invention is limited and defined only by the following claims and equivalents thereto.

1. A method for processing and preserving foods, comprising:
a processing step of holding a seasoned food in a packaging member in a state in which the food is in contact with a dehydrating sheet, and
a preservation step of preserving the food by cold or frozen storage while maintaining the holding state.

2. The method for processing and preserving foods as claimed in claim 1, wherein said packaging member is a packaging bag.

3. The method for processing and preserving foods as claimed in claim 1, wherein said packaging member is a container.

4. The method for processing and preserving foods as claimed in claim 1, wherein said preservation step is performed by frozen storage.

5. The method for processing and preserving foods as claimed in claim 1, wherein said packaging member is designed according to the user of the processed food.

6. The method for processing and preserving foods as claimed in claim 1,
wherein said preservation step contains a transportation step of transporting said processed food while maintaining the holding state and while preserving the food by cold or frozen storage.

7. The method for processing and preserving foods as claimed in claim 1, wherein said food is a fish meet.

8. The method for processing and preserving foods as claimed in claim 7, wherein said processing step is a dried fish production step, a marinated fish production step, or a smoked fish production step.

9. A processed food which is processed by a method comprising:
a processing step of holding a seasoned food in a packaging member in a state in which the food is in contact with a dehydrating sheet, and
a preservation step of preserving the food by cold or frozen storage while maintaining the holding state.

10. The method for processing and preserving foods as claimed in claim 9, wherein said packaging member is a packaging bag.

11. The method for processing and preserving foods as claimed in claim 9, wherein said packaging member is a container.

12. The processed food as claimed in claim 9, wherein said preservation step is preformed by frozen storage.

13. The processed food as claimed in claim 9, wherein said packaging member is designed according to the user of the processed food.

14. The processed food as claimed in claim 9, wherein said preservation step includes a transportation step of transporting said processed food while maintaining the holding state and while preserving the food by cold or frozen storage.

15. The processed food as claimed in any one claims 9, wherein said food is a fish meat.

16. The processed food as claimed in claim 15, wherein said food is a dried fish, a marinated fish or a smoked fish.
